(19) United States
(12) Patent Application Publication
(10) Pub. No.: US 2020/0402013 A1
(43) Pub. Date: Dec. 24, 2020

(54) PREDICTING SUCCESSFUL OUTCOMES

(71) Applicant: Microsoft Technology Licensing, LLC, Redmond, WA (US)

(72) Inventors: Man N. Yeung, Fremont, CA (US); Sandeep Tiwari, Foster City, CA (US); Sumedha K. Swamy, San Jose, CA (US); Nitin Lakhotia, San Francisco, CA (US)

(73) Assignee: Microsoft Technology Licensing, LLC, Redmond, WA (US)

(21) Appl. No.: 16/445,897

(22) Filed: Jun. 19, 2019

(51) Int. Cl. G06Q 10/10; G06N 20/00; G06K 9/62

(52) U.S. Cl. CPC G06Q 10/1053; G06K 9/6201; G06K 9/6259; G06N 20/00

(57) ABSTRACT

The disclosed embodiments provide a system for predicting successful outcomes. During operation, the system determines interaction features characterizing interaction between a moderator of a job and one or more applicants for the job. Next, the system applies a machine learning model to the interaction features to produce a score representing a likelihood of a positive outcome for the job. The system then applies a threshold to the score to generate a predicted outcome for the job. Finally, the system outputs the predicted outcome in association with the job.

### RELATED APPLICATION

The subject matter of this application is related to the subject matter in a co-pending non-provisional application entitled “Dynamic Optimization for Jobs,” having Ser. No. 16/232,862, and filing date 26 Dec. 2018 (Attorney Docket No. LI-902407-US-NP).

### BACKGROUND

### Field

The disclosed embodiments relate to outcomes for machine learning. More specifically, the disclosed embodiments relate to techniques for predicting successful outcomes.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for predicting successful outcomes in an online system in accordance with the disclosed embodiments.

FIG. 3 shows a flowchart illustrating a process of predicting successful outcomes in an online system in accordance with the disclosed embodiments.

FIG. 4 shows a flowchart illustrating a process of training a machine learning model to predict successful outcomes in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for managing content delivered in online systems. For example, the content may include jobs and/or other opportunities that are posted within an online system such as an online network and/or online marketplace.

More specifically, the disclosed embodiments provide a method, apparatus, and system for predicting outcomes associated with jobs (or other opportunities) delivered within the online system. The outcomes can be positive (e.g., hiring of a candidate for a job) or negative (e.g., failing to hire a candidate for the job). Such predictions are performed in the absence of survey results, job changes posted by candidates, and/or publicly available data or voluntarily provided user feedback from candidates or moderators for the jobs.

Instead, the successful outcomes are predicted using features that characterize interaction between moderators of the jobs and candidates that have applied to the jobs, attributes of the jobs, and/or qualifications of the candidates with respect to the jobs. Historical outcomes associated with the features are collected over a period, and the features and labels representing the outcomes are inputted as training data for a machine learning model. In turn, the machine learning model learns to predict the outcomes given the corresponding features.

The machine learning model is subsequently applied to additional features for jobs without confirmed outcomes to predict the likelihood of a successful outcome for each job. For example, the machine learning model outputs a score from 0 to 1 representing the probability that a given job results in a successful hire, given the features for the job.

Scores outputted by the machine learning model are then used to generate performance metrics, insights, recommendations, and/or other output related to delivery and/or use of the jobs in the online system. For example, a threshold is applied to the scores to predict the number and/or proportion of jobs that result in hires. The scores and/or thresholds are used to compare outcomes between treatment and control groups of A/B tests related to delivery of the jobs. The scores and/or thresholds are also, or instead, used to identify minimum and/or threshold amounts of interactions or applicants that result in successful hires. In turn, the scores and/or thresholds can be used to increase the visibility of jobs that lack sufficient interaction and/or applicants and/or recommend budgets for the jobs that increase the interactions, applicants, and/or the likelihood of successful outcomes.

By predicting successful hires and/or other outcomes for jobs based on the jobs' attributes, applicants, and/or interactions between the jobs' moderators and applicants, the disclosed embodiments allow outcomes to be assigned to the jobs without requiring or waiting for survey results, self-reported job changes, and/or other external confirmation of the outcomes. In turn, the outcomes can be used to assess the performance of the online system in delivering the jobs and/or producing successful outcomes for the jobs. The outcomes further allow different features and/or variants of the online system to be tested and/or compared through controlled experimentation, which allows improvements in delivery of the jobs to be identified without significantly impacting the computational efficiency and/or resource overhead of the online system. Finally, the outcomes and corresponding job features can be used to determine types and/or quantities of interactions between the moderators and applicants that result in successful hires for the jobs, which in turn can be used to increase exposure of candidates to jobs that lack sufficient interaction and/or recommend budgets that improve the likelihood of successful outcomes for the jobs.

In contrast, conventional techniques use survey results and/or publicly available data (e.g., profile changes, user posts, press releases, etc.) to confirm successful outcomes for jobs and/or other opportunities. These outcomes are typically received only after a significant delay (e.g., a number of months) and can be incomplete, biased, and/or inaccurate. The incompleteness of the outcomes and/or delay prevents comparison of outcomes between different variants of the online system in an A/B test and/or other type of controlled experiment. At the same time, the inability to account for all outcomes interferes with accurate assessment of the performance of the jobs and/or derivation of subsequent insights or actionable items that improve the performance of the jobs. Consequently, the disclosed embodiments provide technological improvements to computer systems, applications, user experiences, tools, and/or technologies related to delivering online content and/or carrying out activities within online systems.

### Predicting Successful Outcomes

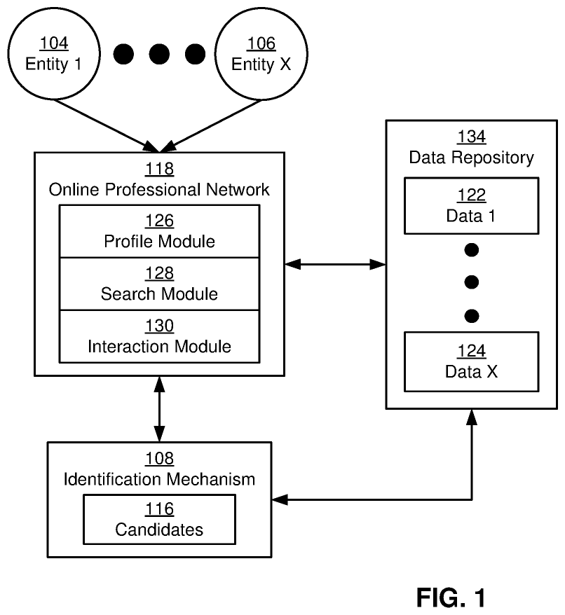

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 is inputted into the machine learning model(s), along with features and/or characteristics of the corresponding opportunities (e.g., required or desired skills, education, experience, industry, title, etc.). In turn, the machine learning model(s) output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and descriptions of the opportunities. The model(s) further adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores and/or associated insights improve the quality of candidates 116, recommendations of opportunities to candidates 116, and/or recommendations of candidates 116 for opportunities. Such rankings may also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

In some embodiments, jobs, advertisements, and/or other types of content displayed or delivered within online network 118 are associated with time-based limitations or constraints. For example, posters of jobs may pay per click, application, and/or other action taken with respect to the jobs by members of online network 118. The posters may set daily budgets for the jobs, from which costs are deducted as the members take the corresponding actions with the jobs. If a job's budget is fully consumed before the end of the day, the job may continue to be delivered to members (e.g., in search results and/or recommendations) until the end of the day without further charging the job's poster. Moreover, jobs with depleted budgets may occupy space in rankings that are shown to the members, which may prevent online network 118 from surfacing other jobs to the members and/or utilizing the budgets for the other jobs.

In one or more embodiments, online network 118 manages daily budgets and/or other constraints or priorities associated with jobs and/or other content in online network 118 by performing dynamic optimization of bid prices for the jobs. For example, online network 118 calculates a new cost per click (CPC) for each job every time the job is outputted in search results and/or a ranking to one or more candidates. The calculated CPC reflects anticipated interactions with the job, improve utilization of the job's budgets, increase the jobs' performance with respect to applications or applicants, and/or accommodate other optimization objectives. As a result, the bid prices allow for a more even exposure of members to the jobs and/or may better reflect the “values” of the jobs within online network 118 and/or recent interactions or feedback related to the jobs. Dynamic optimization of job bids is described in further detail in a co-pending non-provisional application entitled “Dynamic Optimization for Jobs,” having Ser. No. 16/232,862 and filing date 26 Dec. 2018 (Attorney Docket No. LI-902407-US-NP), which is incorporated herein by reference.

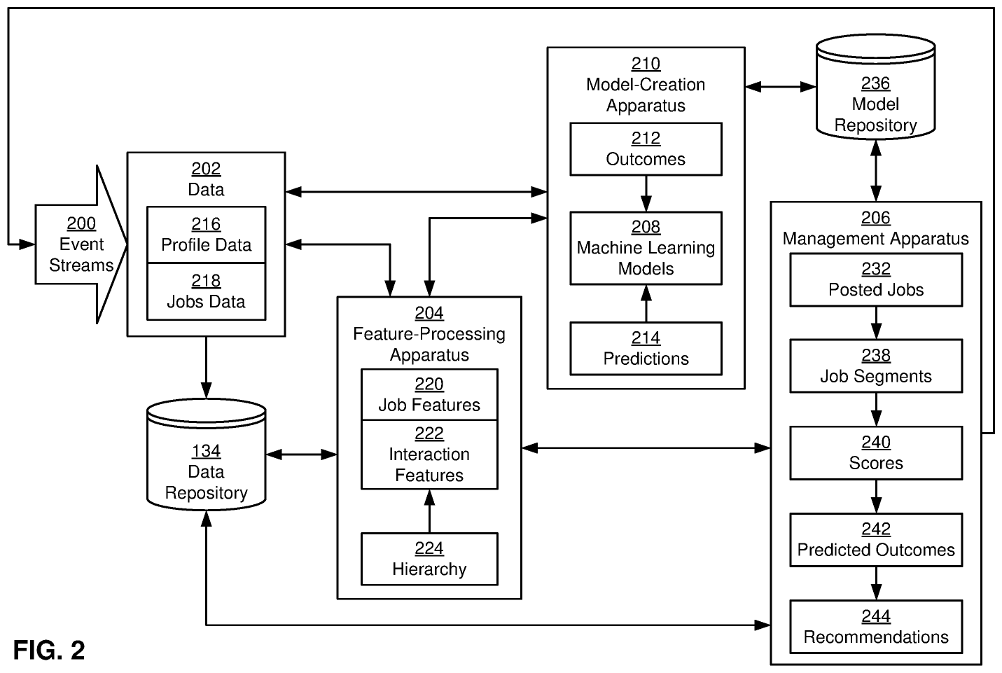

In one or more embodiments, online network 118 includes functionality to improve delivery of jobs (or other content), outcomes related to the jobs, and/or the performance and use of online network 118 by predicting outcomes related to the jobs. As shown in FIG. 2, data repository 134 and/or another primary data store are queried for data 202 that includes profile data 216 for members of an online system (e.g., online network 118 of FIG. 1), as well as jobs data 218 for jobs that are listed or described within or outside the online system.

Profile data 216 includes data associated with member profiles in the online system. For example, profile data 216 for an online professional network includes a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 also, or instead, includes a set of groups to which the user belongs, the user's contacts and/or connections, and/or other data related to the user's interaction with the online system.

Attributes of the members from profile data 216 are optionally matched to a number of member segments, with each member segment containing a group of members that share one or more common attributes. For example, member segments in the online system may be defined to include members with the same industry, title, location, and/or language.

Connection information in profile data 216 is optionally combined into a graph, with nodes in the graph representing entities (e.g., users, schools, companies, locations, etc.) in the online system. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online system. For example, jobs data 218 for a given job or job listing may include a declared or inferred title, company, required or desired skills, responsibilities, qualifications, role, location, industry, seniority, salary range, benefits, and/or member segment.

In one or more embodiments, data repository 134 stores data that represents standardized, organized, and/or classified attributes in profile data 216 and/or jobs data 218. For example, skills in profile data 216 and/or jobs data 218 are organized into a hierarchical taxonomy that is stored in data repository 134. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online system. In a fifth example, data repository 134 includes standardized time periods (e.g., daily, weekly, monthly, quarterly, yearly, etc.) that can be used to retrieve profile data 216, user activity 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform such as Apache Kafka (Kafka™ is a registered trademark of the Apache Software Foundation). One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

A feature-processing apparatus 204 uses data 202 from event streams 200 and/or data repository 134 to calculate a set of features for a job. For example, feature-processing apparatus 204 executes on an offline, periodic, and/or batch-processing basis to produce features for a large number of jobs and/or candidate-job pairs (e.g., combinations of members in the community and jobs for which the members are qualified). In another example, feature-processing apparatus 204 generates features in an online, nearline, and/or on-demand basis based on recent activity related to posting of the job and/or after a job has been posted for a pre-specified period (e.g., a number of days, weeks, or months).

In one or more embodiments, feature-processing apparatus 204 generates job features 220 for jobs and interaction features 222 between moderators (e.g., job posters, recruiters, hiring managers, etc.) of the jobs and applicants for the jobs. Job features 220 include attributes related to a job (or opportunity) that has been posted in the online system. For example, job features 220 include a declared or inferred job title, function, company (i.e., employer), industry, seniority, desired skill and experience, salary range, and/or location. Job features 220 also, or instead, include a company segment that categorizes the size and/or hiring capacity of the company. The company segment includes values such as, but not limited to, “small,” “medium,” “growth,” “staffing,” and/or “enterprise.” Job features 220 also, or instead, include a payment model for the job, such as pay per click (PPC), pay per job application, and/or a prepaid fixed price throughout the job's lifetime.

Interaction features 222 characterize interaction between a moderator of a job and applicants for the job (i.e., candidates that have applied to the job). In some embodiments, interaction features 222 include counts of various types of interaction between the moderator and applicants. For example, interaction features 222 include the number of applicants messaged by the moderator, the number of applicants with resumes viewed by the moderator, and/or the number of applicants with profiles viewed by the moderator.

Interaction features 222 also, or instead, characterize the numbers and/or types of applicants for the job. More specifically, interaction features 222 include a number of applicants that are characterized as “qualified applicants” for the job, as well as a number of applicants that are characterized as non-qualified applicants for the job. Feature-processing apparatus 204 identifies an applicant as a qualified applicant when the applicant matches the job on three out of the following four attributes: seniority, function, industry, and country. Feature-processing apparatus 204 also, or instead, determines whether or not an applicant is a qualified applicant by calculating match scores between a set of attributes for the applicant (e.g., educational background, function, location, level of experience, industry, and/or skills) and a corresponding set of attributes for the job. The match scores are combined with a set of weights to produce a quality score for the applicant with respect to the job, and a threshold is applied to the quality score to classify the applicant as qualified or not qualified.

In one or more embodiments, feature-processing apparatus 204 generates counts of qualified applicants or non-qualified applicants for the job that have not been the subject of messages, profile views, resume views, and/or other types of interaction from the moderator. Thus, once an applicant is the recipient or target of an interaction that is tracked in interaction features 222, the applicant is removed from a corresponding count of qualified applicants or non-qualified applicants and added to a count of applicants targeted by the corresponding interaction from the moderator.

In some embodiments, feature-processing apparatus 204 groups and/or weights interaction features 222 by time periods over which the corresponding actions were made after the job is posted. For example, feature-processing apparatus 204 generates counts of moderator-applicant interactions, qualified applicants, and/or non-qualified applicants by the number of days since the job was posted. Feature-processing apparatus 204 optionally multiplies the counts for a given day by a weight that is highest right after the job is posted and decreases over time. Thus, counts of moderator-applicant interactions and/or qualified or non-qualified applicants in interaction features 222 are associated with higher “value” immediately after the job is posted than counts of moderator-applicant interactions and/or applicants that are received in subsequent days or weeks. Feature-processing apparatus 204 then aggregates the weighted counts into overall counts in interaction features 222. Alternatively, feature-processing apparatus 204 maintains weighted or non-weighted counts of moderator-applicant interactions, qualified applicants, and/or non-qualified applicants for different days after posting of the job as separate sets of interaction features 222 for the job.

In one or more embodiments, feature-processing apparatus 204 processes and/or filters interaction features 222 based on a hierarchy 224 of interaction features 224. In these embodiments, hierarchy 224 includes a ranking or ordering of interaction features 222. For example, hierarchy 224 includes the following ranking of interaction features 222:
1. Number of applicants messaged by the moderator
2. Number of applicants with resumes viewed by the moderator
3. Number of applicants with profiles viewed by the moderator
4. Number of qualified applicants that have not been targeted with messages, resume views, or profile views by the moderator
5. Number of non-qualified applicants that have not been targeted with messages, resume views, or profile views by the moderator
   In the example hierarchy 224 above, the number of applicants messaged by the moderator has the highest rank, and the number of non-qualified applicants that have not been targeted with interactions from the moderator has the lowest rank.

More specifically, feature-processing apparatus 204 generates interaction features 222 for a given job by determining the highest-ranked interaction feature with a non-zero value for the job and converting remaining interaction features 222 for the job that are below the highest-ranked feature in hierarchy 224 to zero values. Continuing with the above example, a job includes five applicants messaged by the moderator and three applicants with profiles viewed by the moderator. Because the number of applicants messaged by the moderator has the highest rank in hierarchy 224, feature-processing apparatus 204 assigns a value of 5 to an interaction feature representing the number of applicants messaged by the moderator and a value of 0 to all remaining interaction features 222, including a feature representing the number of applicants with profiles viewed by the moderator.

After job features 220 and interaction features 222 are generated for one or more posted jobs 232, feature-processing apparatus 204 stores the features in data repository 134 for subsequent retrieval and use. Feature-processing apparatus 204 may also, or instead, provide the features to a model-creation apparatus 210, a management apparatus 206, and/or another component of the system for use in creating and/or executing machine learning models 208 using the features.

Model-creation apparatus 210 trains and/or updates one or more machine learning models 208 using sets of features from feature-processing apparatus 204, outcomes 212 associated with the feature sets, and predictions 214 produced from the feature sets. In general, model-creation apparatus 210 may produce machine learning models 208 that generate predictions and/or estimates related to outcomes 212 for posted jobs 232. Outcomes 212 include successful or positive outcomes, such as hiring of an applicant for a posted job. Outcomes 212 also include non-successful or negative outcomes, such as the lack of hiring of an applicant for a posted job.

In some embodiments, model-creation apparatus 210 collects outcomes 212 from jobs that have been posted over a period (e.g., a number of months, a year, etc.). A job posted within that period is associated with a positive outcome if an applicant for the job updates his/her profile data 216 to indicate a change to the job, the moderator for the job confirms hiring of an applicant for the job, and/or the moderator or applicant respond to a survey indicating that a hire was successfully made for the job. A job posted within that period is associated with a negative outcome if the job remains open for longer than a threshold amount of time (e.g., a number of weeks or months), the moderator discontinues posting of the job and confirms a lack of successful hire for the job, and/or no applicants for the job have updated profile data 216 indicating a change to the job.

Next, model-creation apparatus 210 uses labels representing outcomes 212 and corresponding job features 220 and interaction features 222 for the jobs to update parameters of machine learning models 208. For example, model-creation apparatus 210 generates, for each job, a label of 1 for a positive outcome and a label of 0 for a negative outcome. Model-creation apparatus 210 inputs job features 220, interaction features 222, and the labels as training data for one or more logistic regression models, random forests, and/or other types of machine learning models 208. Model-creation apparatus 210 then uses a training technique and/or one or more hyperparameters to update parameter values of machine learning models 208 so that predictions 214 outputted by machine learning models 208 reflect labels for the corresponding outcomes 212. In turn, predictions 214 range in value from 0 to 1 and represent the probability of a successful or positive outcome for the corresponding job.

In one or more embodiments, model-creation apparatus 210 uses a cross-validation technique to train and/or evaluate multiple machine learning models 208. For example, model-creation apparatus 210 divides the training data into multiple subsets for multiple machine learning models 208. Machine learning models 208 include different types of models (e.g., logistic regression, random forest, deep learning, etc.), combinations of input features, hyperparameters, and/or other attributes or characteristics that potentially affect the performance of each machine learning model. Model-creation apparatus 210 uses 80% of the training data to train each machine learning model and reserves a different 20% of the training data as validation data for each machine learning model. After machine learning models 208 are trained, model-creation apparatus 210 uses the validation data for each machine learning model to calculate performance metrics such as precision, recall, receiver operating characteristic (ROC) area under the curve (AUC), F1 score, and/or number of successful outcomes 212 predicted by the machine learning model. Model-creation apparatus 210 then selects the machine learning model with the best performance metrics and retrains the model using the entire set of training data.

In one or more embodiments, model-creation apparatus 210 produces different machine learning models 208 for different job segments 238 of jobs posted or delivered in the online system. Job segments 238 represent different sources, hosting locations, and/or other characteristics related to posting or delivery of the jobs. For example, job segments 238 include a first job segment representing paid jobs that receive applications at an offsite source that is external to the online system (e.g., a “careers” page on a company's external website). Job segments 238 also include a second job segment representing paid jobs that receive applications at an onsite source within the online system (e.g., a jobs module or feature). Job segments 238 further include a third job segment representing free (unpaid) jobs that are imported into the online system through distribution partnerships, application-programming interfaces (APIs), scraping, data feeds, and/or other data sources.

To generate machine learning models 208 for different job segments 238, model-creation apparatus 210 groups job features 220, interaction features 222, and the corresponding outcomes by job segments 238. Model-creation apparatus 210 then trains and/or validates a separate machine learning model using training data for each job segment. Continuing with the previous example, model-creation apparatus 210 creates a first machine learning model that predicts outcomes 212 for paid offsite jobs, a second machine learning model that predicts outcomes 212 for paid onsite jobs, and a third machine learning model that predicts outcomes 212 for free jobs.

After machine learning models 208 are trained and/or updated, model-creation apparatus 210 stores parameters of machine learning models 208 in a model repository 236. For example, model-creation apparatus 210 replaces old values of the parameters in model repository 236 with the updated parameters, or model-creation apparatus 210 stores the updated parameters separately from the old values (e.g., by storing each set of parameters with a different version number of the corresponding machine learning model).

A management apparatus 206 uses the latest versions of machine learning models 208 to generate scores 240, predicted outcomes 242 and/or recommendations 244 related to additional posted jobs 232. First, management apparatus 206 identifies posted jobs 232 as jobs that have been posted in the online system for a minimum and/or maximum period (e.g., a number of days, weeks, months, etc.). Management apparatus 206 also identifies job segments 238 of posted jobs 232 and retrieves, from model-creation apparatus 210 and/or model repository 236, the latest parameters of one or more machine learning models 208 that have been generated for job segments 238.

For each job in posted jobs 232, management apparatus 206 retrieves job features 220 and interaction features 222 from feature-processing apparatus 204 and/or data repository 134. Next, management apparatus 206 applies a machine learning model for the job segment of the job to the features to generate a score (e.g., scores 240) representing the job's likelihood of a positive outcome. As with the generation of features inputted into machine learning models 208, scores 240 may be produced in an offline, batch-processing, and/or periodic basis (e.g., from batches of features), or scores 240 may be generated in an online, nearline, and/or on-demand basis (e.g., when a moderator of a job accesses the online system, a candidate applies for a job, and/or the moderator interacts with an applicant for a job).

Management apparatus 206 also applies a threshold to scores 240 to generate predicted outcomes 242 for posted jobs 232. For example, management apparatus 206 selects a numeric threshold representing a certain probability of a successful hire in scores 240 and/or a certain percentile in the distribution of scores 240. Management apparatus 206 assigns positive predicted outcomes 242 to jobs with scores 240 that meet or exceed the threshold and negative predicted outcomes 242 to jobs with scores 240 that fall below the threshold.

Finally, management apparatus 206 generates recommendations 244 based on scores 240 and/or predicted outcomes 242. In some embodiments, management apparatus 206 aggregates positive and negative predicted outcomes 242 into a performance metric representing the hiring rate for posted jobs 232. Management apparatus 206 also analyzes parameters, intermediate values, and/or other attributes of machine learning models 208 used to generate scores 240 to identify thresholds for moderator-applicant interactions (e.g., messages, resume views profile views, etc.) and/or numbers of qualified or non-qualified applicants that lead to positive predicted outcomes 242. Management apparatus 206 also outputs the hiring rate and/or thresholds for use in evaluating the performance of the online system and/or achieving successful outcomes. In turn, other components of the system are able to use the hiring rate and/or other metrics generated from predicted outcomes 242 to perform A/B tests and/or experiments that evaluate different features and/or mechanisms for delivering jobs in the online system.

Management apparatus 206 also, or instead, uses scores 240 and/or predicted outcomes 242 to generate recommendations 244 related to subsequent delivery of posted jobs 232. In some embodiments, management apparatus 206 and/or another component of the system control the delivery and/or pricing of jobs in the online system using the following equations:

R_{m,j,t}=pctr_{m,j}*bid_{m,j,t}+μ*pApply_{m,j}

bid_{m,j,t}=bid_{m,j}*f_{j,t}(Sa_{j,t},Sp_{j,t})*f_{m,j}(h_{apply},h_{quality})

In the above equations, R_{m,j,t} represents a ranking score R for a member m, job j, and time t; pctr_{m,j} represents a predicted click-through rate by the member for the job; bid_{m,j,t} represents a cost per action (CPA) (e.g., a CPC) for the job, which is calculated as a dynamic bid price for the job with respect to the member and the time; μ represents a balancing factor that balances revenue with engagement in the ranking; and pApply_{m,j} represents the likelihood of the member applying to the job. In turn, the dynamic bid price is calculated from a value of an initial price for the job represented by bid_{m,j}, a first dynamic adjustment to the initial price represented by f_{m,j}, and a second dynamic adjustment to the initial price represented by f_{m,j}.

As described in the above-referenced application, f_{j,t} is calculated from Sa_{j,t}, which represents an actual spending for the job at the time, and Sp_{j,t}, which represents the expected spending for the job at that time. In other words, f_{j,t} can be used to “boost” or “throttle” the delivery of the job (e.g., by increasing or decreasing the job's position in the ranking) based on the utilization of the job's budget at time t. Similarly, f_{m,j} is calculated from h_{apply},which represents a measure of application rates associated with the job, and h_{quality}, which represents a measure of applicant quality associated with the job. Thus, f_{m,j} includes a “performance” score that adjusts the ranking score to control for the quality of applicants and/or the application rate for the job.

Consequently, the equations above can be used to perform multi-objective optimization of content delivery by ranking the content items according to a number of optimization objectives. The optimization objectives include, but are not limited to, a revenue component represented by pctr_{m,j}*bid_{m,j,t} and an engagement component represented by μ*pApply_{m,j}.

In turn, management apparatus 206 uses the score and/or predicted outcome for each posted job in one or more components of the ranking score and/or CPA for the job. For example, management apparatus 206 includes the predicted likelihood of a positive outcome for a job as an element in h_{apply}, h_{quality}, and/or f_{m,j}. As a result, a job with a higher predicted likelihood of a positive outcome can be ranked lower than other jobs with lower predicted likelihoods of positive outcomes to increase the exposure of candidates to the other jobs, the number of applicants for the other jobs, and/or subsequent interactions between moderators of the other jobs and the applicants.

Management apparatus 206 also includes functionality to recommend a budget for a job that improves the likelihood of a successful hire for the job. For example, management apparatus 206 compares the number of existing qualified applicants, non-qualified applicants, and/or interactions between the moderator and applicants for a job with the corresponding thresholds that result in a positive predicted outcome. Management apparatus 206 estimates the number of clicks required to produce a new applicant for the job and/or subsequent interaction between the moderator and the applicant. Management apparatus 206 also determines a CPC for the job and outputs a recommended budget for the job that accounts for the number of clicks and the CPC for the job.

By predicting successful hires and/or other outcomes for jobs based on the jobs' attributes, applicants, and/or interactions between the jobs' moderators and applicants, the disclosed embodiments allow outcomes to be assigned to the jobs without requiring or waiting for survey results, self-reported job changes, and/or other external confirmation of the outcomes. In turn, the outcomes can be used to assess the performance of the online system in delivering the jobs and/or producing successful outcomes for the jobs. The outcomes further allow different features and/or variants of the online system to be tested and/or compared through controlled experimentation, which allows improvements in delivery of the jobs to be identified without significantly impacting the computational efficiency and/or resource overhead of the online system. Finally, the outcomes and corresponding job features can be used to determine types and/or quantities of interactions between the moderators and applicants that result in successful hires for the jobs, which in turn can be used to increase exposure of candidates to jobs that lack sufficient interaction and/or recommend budgets that improve the likelihood of successful outcomes for the jobs.

In contrast, conventional techniques use survey results and/or publicly available data (e.g., profile changes, user posts, press releases, etc.) to confirm successful outcomes for jobs and/or other opportunities. These outcomes are typically received only after a significant delay (e.g., a number of months) and can be incomplete, biased, and/or inaccurate. The incompleteness of the outcomes and/or delay prevents comparison of outcomes between different variants of the online system in an A/B test and/or other type of controlled experiment. At the same time, the inability to account for all outcomes interferes with accurate assessment of the performance of the jobs and/or derivation of subsequent insights or actionable items that improve the performance of the jobs. Consequently, the disclosed embodiments provide technological improvements to computer systems, applications, user experiences, tools, and/or technologies related to delivering online content and/or carrying out activities within online systems.

Those skilled in the art will appreciate that the system of FIG. 2 may be implemented in a variety of ways. First, feature-processing apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Feature-processing apparatus 204, model-creation apparatus 210, and management apparatus 206 may additionally be implemented together and/or separately by one or more hardware and/or software components and/or layers.

Second, a number of machine learning models 208 and/or techniques may be used to generate predictions 214, scores 240, predicted outcomes 242, and/or recommendations 244. For example, the functionality of each machine learning model may be provided by a regression model, artificial neural network, support vector machine, decision tree, gradient boosted tree, random forest, naïve Bayes classifier, Bayesian network, clustering technique, collaborative filtering technique, deep learning model, hierarchical model, ensemble model, and/or another type of machine learning technique. The retraining or execution of each machine learning model may also be performed on an offline, online, and/or on-demand basis to accommodate requirements or limitations associated with the processing, performance, or scalability of the system and/or the availability of features and outcomes 212 used to train the machine learning model. Multiple versions of a machine learning model may further be adapted to different subsets of candidates (e.g., different member segments in the community) and/or jobs (e.g., free jobs, paid jobs, jobs with onsite sources, jobs with offsite sources, jobs from different industries, jobs for different company sizes, etc.). Conversely, the same machine learning model may be used to generate scores 240 for all jobs.

Third, the system of FIG. 2 may be adapted to infer positive and/or negative outcomes for other platforms. For example, the system may be used to infer positive, negative, and/or other outcomes with a recruiting tool, marketing or advertising campaign, sales tool, online dating service, online marketplace, recommendation system, and/or other type of platform for procuring, generating, or providing goods, products, services, content, and/or conversions.

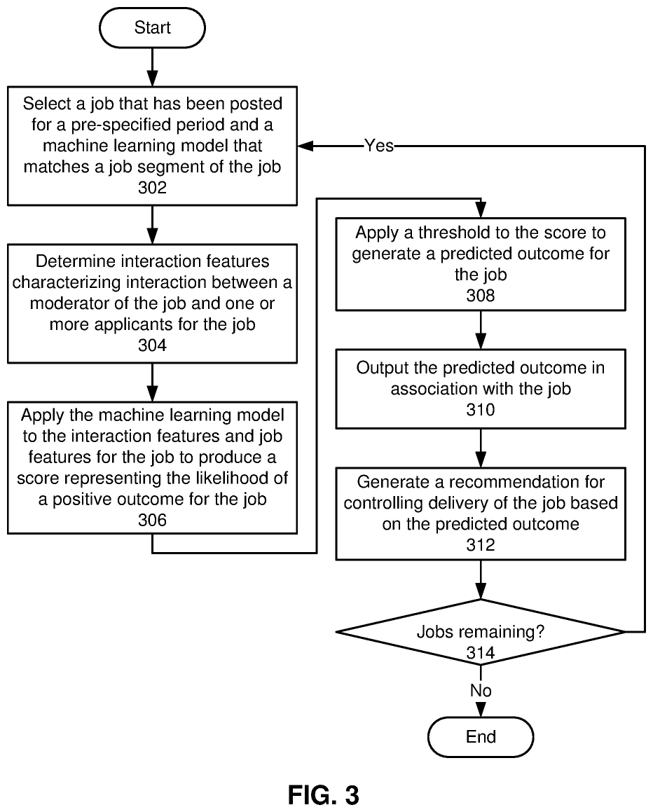

FIG. 3 shows a flowchart illustrating a process of predicting successful outcomes in an online system in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a job that has been posted for a pre-specified period and a machine learning model that matches a job segment of the job are selected (operation 302). For example, the job is selected when the job has been posted in the online system for a minimum and/or maximum number of days, weeks, and/or months. The job segment may represent paid jobs, free jobs, onsite sources for applications to the jobs, and/or offsite sources for applications to the jobs.

Next, interaction features characterizing interaction between a moderator of the job and one or more applicants for the job are determined (operation 304). For example, the interaction features include a number of applicants messaged by the moderator, a number of applicants with profiles viewed by the moderator, a number of applicants with resumes viewed by the moderator, a number of qualified applicants, and/or a number of non-qualified applicants. Values of the interaction features are generated based on a hierarchy of the interaction features. For example, the hierarchy includes a highest rank for the number of applicants messaged by the moderator, a second-highest rank for the number of applicants with resumes viewed by the moderator, a third-highest rank for the number of applicants with profiles viewed by the moderator, a fourth-highest rank for the number of qualified applicants for the job, and a fifth-highest rank for the number of non-qualified applicants for the job. The hierarchy is used to determine the highest-ranked interaction feature with a non-zero value for the job, and remaining interaction features for the job that are below the highest-ranked feature in the hierarchy are converted to zero values.

The machine learning model is applied to the interaction features and job features for the job to produce a score representing the likelihood of a positive outcome for the job (operation 306). For example, the job features include a location, function, industry, seniority, title, skill, salary (or salary range), company segment, and/or payment model for the job. After the interaction features and job features are inputted into the machine learning model, the machine learning model outputs a score from 0 to 1 representing the probability of a successful hire for the job.

A threshold is applied to the score to generate a predicted outcome for the job (operation 308). For example, the threshold includes a numeric probability of a positive outcome and/or a score representing a percentile in the distribution of scores outputted by the machine learning model. If the score meets or exceeds the threshold, the job is assigned a positive predicted outcome. If the score does not meet the threshold, the job is assigned a negative predicted outcome.

The predicted outcome is outputted in association with the job (operation 310), and a recommendation for controlling delivery of the job is generated based on the score and/or predicted outcome (operation 312). For example, the predicted outcome is stored in a data store and/or outputted to track the performance of the online system and/or job. In another example, the score and/or predicted outcome are used to adjust the job's position in rankings that are displayed to candidates and/or determine a budget for the job that results in the number of applicants and/or interactions required to achieve a successful hire.

Operation 302-312 may be repeated for a number of remaining jobs (operation 314). For example, machine learning models may be used to generate scores for a set of jobs that have been posted for a pre-specified period (operations 302-306), and predicted outcomes and recommendations are generated for the jobs based on the cores (operations 308-312). In turn, the scores, predicted outcomes, and/or recommendations may be used to assess the performance of the online system, test variants of the online system, and/or improve outcomes related to the jobs.

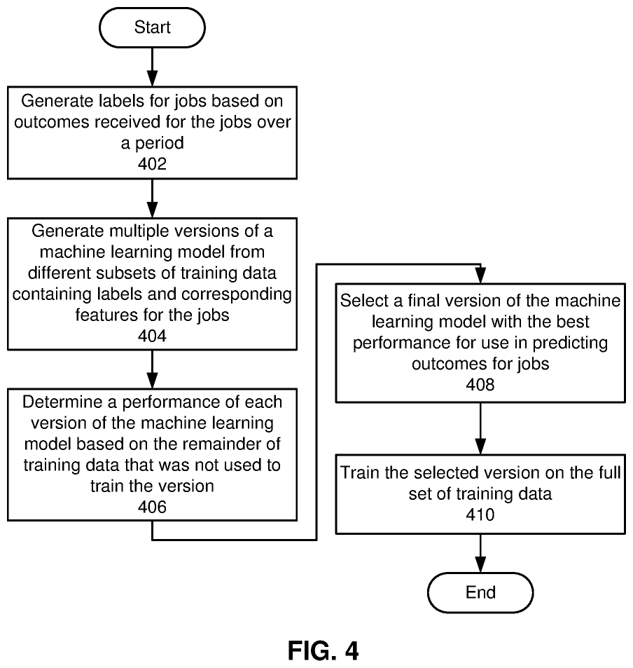

FIG. 4 shows a flowchart illustrating a process of training a machine learning model to predict successful outcomes in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, labels for jobs are generated based on outcomes received for the jobs over a period (operation 402). For example, the outcomes may be collected over a number of weeks, months, or years. A positive label of 1 is generated for a job with a positive outcome (e.g., hiring of an applicant for the job), and a negative label of 0 is generated for a job with a negative outcome (e.g., lack of a successful hire for the job).

Next, multiple versions of a machine learning model are generated from different subset of training data containing labels and corresponding features for the jobs (operation 404), and a performance of each version of the machine learning model is determined based on the remainder of the training data that was not used to train the version (operation 406). For example, a k-fold cross-validation technique is used to produce 10 versions of the machine learning model. Different versions of the machine learning model may vary in features, model type, hyperparameters, and/or other attributes that affect the resulting performance of the version. Each version is trained using a different 80% of training data and validated using the remaining 20%. After the version is trained, one or more performance metrics are generated based on the 20% of training data not used to train the version.

A final version of the machine learning model with the best performance is selected for use in predicting outcomes for jobs (operation 408), and the selected version is trained on the full set of training data (operation 410). Continuing with the above example, the version with the best performance metrics is selected as the final version. The version is then retrained using all of the training data before the version is used to predict outcomes for additional jobs.

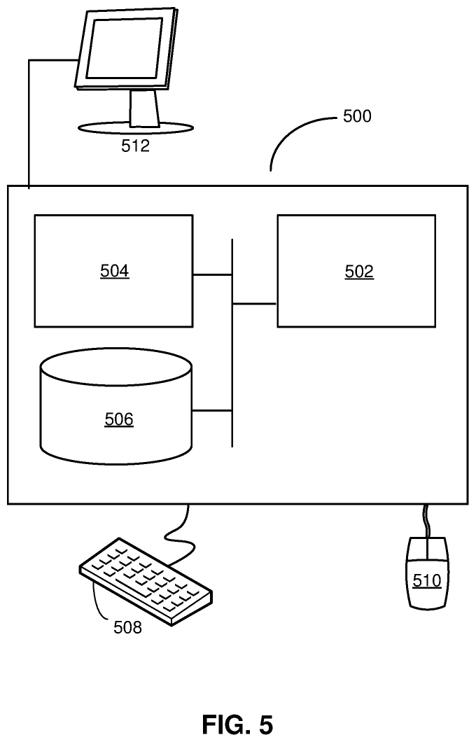

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 also includes input/output (I/O) devices such as a keyboard 508, a mouse 510, and a display 512.

Computer system 500 includes functionality to execute various components of the present embodiments. In particular, computer system 500 includes an operating system (not shown) that coordinates the use of hardware and software resources on computer system 500, as well as one or more applications that perform specialized tasks for the user. To perform tasks for the user, applications obtain the use of hardware resources on computer system 500 from the operating system, as well as interact with the user through a hardware and/or software framework provided by the operating system.

In one or more embodiments, computer system 500 provides a system for predicting successful outcomes. The system includes a feature-processing apparatus, a model-creation apparatus, and a management apparatus, one or more of which may alternatively be termed or implemented as a module, mechanism, or other type of system component. The feature-processing apparatus determines interaction features characterizing interaction between a moderator of a job and one or more applicants for the job. Next, the model-creation apparatus generates labels for additional jobs based on outcomes received for the jobs over a period and inputs additional features for the additional jobs with the labels as training data for a machine learning model. The management apparatus then applies the machine learning model to the interaction features to produce a score representing a likelihood of a positive outcome for the job. The management apparatus also applies a threshold to the score to generate a predicted outcome for the job. Finally, the management apparatus outputs the predicted outcome in association with the job.

In addition, one or more components of computer system 500 may be remotely located and connected to the other components over a network. Portions of the present embodiments (e.g., feature-processing apparatus, model-creation apparatus, management apparatus, data repository, model repository, online network, etc.) may also be located on different nodes of a distributed system that implements the embodiments. For example, the present embodiments may be implemented using a cloud computing system that generates predicted outcomes and/or recommendations related to a set of remote jobs and/or applicants.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining interaction features characterizing interaction between a moderator of a job and one or more applicants for the job;
applying, by one or more computer systems, a machine learning model to the interaction features to produce a score representing a likelihood of a positive outcome for the job;
applying, by the one or more computer systems, a threshold to the score to generate a predicted outcome for the job; and
outputting the predicted outcome in association with the job.

2. The method of claim 1, further comprising:
generating labels for additional jobs based on outcomes received for the jobs over a period; and
inputting additional features for the additional jobs with the labels as training data for the machine learning model.

3. The method of claim 2, wherein inputting the additional features for the additional jobs with the labels as the training data for the machine learning model comprises:
generating multiple versions of the machine learning model from different subsets of the training data;
for each version of the machine learning model, determining a performance of the version based on a remainder of the training data that was not used to train the version; and
selecting a final version of the machine learning model with the best performance for use in predicting outcomes for jobs.

4. The method of claim 1, further comprising:
selecting the machine learning model to match a job segment of the job.

5. The method of claim 4, wherein the job segment comprises at least one of:
paid jobs;
free jobs;
onsite sources for jobs; and
offsite sources for jobs.

6. The method of claim 1, further comprising:
applying the machine learning model to job features for the job to produce the score.

7. The method of claim 6, wherein the job features comprise at least one of:
a location;
a function;
an industry;
a seniority;
a title;
a skill;
a salary;
a company segment; and
a payment model for the job.

8. The method of claim 1, wherein determining the interaction features comprises:
determining, based on a hierarchy of the interaction features, a highest-ranked interaction feature with a non-zero value for the job; and
converting remaining interaction features for the job that are below the highest-ranked feature in the hierarchy to zero values.

9. The method of claim 8, wherein the hierarchy of the interaction features comprises:
a first rank for a first number of applicants messaged by the moderator;
a second rank that is below the first rank for a second number of applicants with resumes viewed by the moderator; and
a third rank that is below the second rank for a third number of applicants with profiles viewed by the moderator.

10. The method of claim 8, wherein the hierarchy of the interaction features comprises:
a first rank for a first number of qualified applicants for the job; and
a second rank that is below the first rank for a second number of non-qualified applicants for the job.

11. The method of claim 1, further comprising:
selecting the job for use in generating the predicted outcome after the job has been posted for a pre-specified period.

12. The method of claim 1, further comprising:
generating a recommendation for controlling delivery of the job based on the predicted outcome.

13. The method of claim 12, wherein the recommendation comprises at least one of:
an adjustment to subsequent delivery of the job; and
a budget for the job.

14. A system, comprising:
one or more processors; and
memory storing instructions that, when executed by the one or more processors, cause the system to:
determine interaction features characterizing interaction between a moderator of a job and one or more applicants for the job;
apply a machine learning model to the interaction features and job features for the job to produce a score representing a likelihood of a positive outcome for the job;
apply a threshold to the score to generate a predicted outcome for the job; and
output the predicted outcome in association with the job.

15. The system of claim 14, wherein the memory further stores instructions that, when executed by the one or more processors, cause the system to:
generate labels for additional jobs based on outcomes received for the jobs over a period; and
input additional features for the additional jobs with the labels as training data for the machine learning model.

16. The system of claim 15, wherein inputting the additional features for the additional jobs with the labels as the training data for the machine learning model comprises:
generating multiple versions of the machine learning model from different subsets of the training data;
for each version of the machine learning model, determining a performance of the version based on a remainder of the training data that was not used to train the version; and
selecting a final version of the machine learning model with the best performance for use in predicting outcomes for jobs.

17. The system of claim 14, wherein determining the interaction features comprises:
determining, based on a hierarchy of the interaction features, a highest-ranked interaction feature with a non-zero value for the job; and
converting remaining interaction features for the job that are below the highest-ranked feature in the hierarchy to zero values.

18. The system of claim 14, wherein the interaction features comprise at least one of:
a first number of applicants messaged by the moderator;
a second number of applicants with resumes viewed by the moderator;
a third number of applicants with profiles viewed by the moderator a fourth number of qualified applicants for the job; and
a fifth number of non-qualified applicants for the job.

19. The system of claim 14, wherein the job features comprise at least one of:
a location;
a function;
an industry;
a seniority;
a title;
a skill;
a salary;
a company segment; and
a payment model for the job.

20. A non-transitory computer-readable storage medium storing instructions that when executed by a computer cause the computer to perform a method, the method comprising:
determining interaction features characterizing interaction between a moderator of a job and one or more applicants for the job;
applying a machine learning model to the interaction features to produce a score representing a likelihood of a positive outcome for the job;
applying a threshold to the score to generate a predicted outcome for the job; and
outputting the predicted outcome in association with the job.
